(19) United States
(12) Patent Application Publication
(10) Pub. No.: US 2016/0069555 A1
(43) Pub. Date: Mar. 10, 2016

(54) Head-Hoop Type Connector and LED Lamp Using Same

(71) Applicant: Bingshui CHEN, (US)

(72) Inventor: Bingshui Chen, Xiamen (CN)

(21) Appl. No.: 14/786,982

(22) PCT Filed: Mar. 19, 2014
(86) PCT No.: PCT/CN2014/073694

§ 371 Date: Oct. 25, 2015

(51) Int. Cl. F21V 23/06; H01R 4/48; F21K 99/00

(52) U.S. Cl. CPC F21V 23/06; F21K 9/30; H01R 4/48

(57) ABSTRACT

A head-hoop type connector includes a bottom plate. The bottom plate is provided thereon with weld legs for realizing an electric connection with a light source plate. The bottom plate is provided thereon with a socket for a pin to penetrate through. Two side edges, i.e. a left side edge and a right side edge, of the bottom plate extend upwards first, then relatively extend to a position above the socket and are then bent to form an elastic clamp for inserting the pin in order to realize the electric connection. The structure of the connector is simpler, so a plastic seat for installation can be omitted. The mounting structure is more compact. The connector can be suitable for manufacturing LED lamps with different sizes and types, especially a small-sized LED lamp, and the application range is wider.

### BACKGROUND OF THE INVENTION

1. Field of the Invention

This invention relates to a connector and relates particularly to a head-hoop type connector suitable for a light source plate of an LED lamp and to an LED lamp which applies the head-hoop type connector.

2. Description of the Related Art

Typically, the power connection of an LED lamp is conducted by conducting wires. Two ends of the conducting wire are respectively welded to a light source plate and a drive plate to provide electricity to an LED chip of the light source plate. This electric connection has a complicated operation and causes a high cost for installing the LED lamp. Thus, an automatic installation cannot be executed.

Accordingly, different kinds of direct-inserting structures are invented. The structure is generally made by mounting a connector on a light source plate and installing a pin on a drive plate. The insertion of the pin into the connector replaces the conventional conducting wire and simplifies the electrical connecting structure between the light source plate and the drive plate of the LED lamp This connection is more convenient to operate, easy to install and process and capable of fulfilling the automatic production.

However, the conventional direct-inserting structure is still complicated, especially when the connector installed on the light source plate has a larger volume, and such connector cannot be suitable to make a small-sized LED lamp. Thus, the application range is restricted.

### SUMMARY OF THE INVENTION

An object of this invention is to provide a head-hoop type connector with a simpler structure and a more compact structure for installation which adapts to LED lamps with different sizes and types and attains a broader application range.

A further object of this invention is to provide an LED lamp which has a simpler structure and a more compact structure for installation.

To attain the aforementioned objects, this invention is described as follows:

A head-hoop type connector includes a bottom plate. The bottom plate is provided thereon with weld legs to have an electric connection with a light source plate. The bottom plate forms a socket where a pin can penetrate. Two side edges, i.e. a left side edge and a right side edge, of the bottom plate extend upwards first, then relatively extend to a position above the socket and thence get bent to form an elastic clamp where the pin can be inserted to conduct an electric connection.

Preferably, the two side edges of the bottom plate extend upwards first, then relatively extend to a position above the socket and thence get bent downwards to form an elastic clamp

Preferably, the two side edges of the bottom plate extend upwards first, then relatively extend to a position above the socket and thence get bent upwards to form an elastic clamp

Preferably, the two side edges of the bottom plate extend upwards first, relatively extend to a position above the socket, then go upwards to further stretch left and right, and thence get bent to form an elastic clamp

Preferably, two weld legs are respectively disposed on a left side of the bottom plate, and two weld legs are respectively disposed on a right side of the bottom plate. In other words, the bottom plate has four corners, each of which forms a welding leg. Thus, the bottom plate has four weld legs disposed thereon.

Preferably, one welding leg is disposed in the front of the bottom plate, and another one welding leg is disposed in the rear of the bottom plate. Thus, the bottom plate has two weld legs disposed thereon. Specifically, the front and the rear of the bottom plate can extend downwards and then get bent outwards or inwards to form weld legs. Such weld legs can further extend to the left and to the right in order to increase the welding area and install the structure more firmly.

Preferably, the elastic clamp forms a leading part which leads an insertion of the pin.

Preferably, the head-hoop type connector is formed by pressing and bending a one-piece material.

An LED lamp is disclosed. A drive plate and a light source plate are installed within the LED lamp. The drive plate is located below the light source plate. The head-hoop type connector is installed on the light source plate. An opening is formed on the light source plate relative to the socket for an insertion of the pin. The pin can be installed on the drive plate or be integrated into one piece. The pin is inserted into the elastic clamp of the head-hoop type connector to provide an electric connection.

Preferably, an insulation sleeve is disposed around a place of the pin corresponding to the opening of the light source plate.

Because the weld legs of the bottom plate are in electric connection with the light source plate and two side edges of the bottom plate extend and get bent to form an elastic clamp for the penetration of the pin to execute an electric connection, this invention has a simpler structure in comparison with the prior art, omits the use of plastic seats, obtains a more compact structure for installation and adapts to LED lamps with different sizes and types, especially to small-sized LED lamps, in order to obtain a broader application range.

With regard to LED lamps with the same sizes and types, the more compact installation of this invention allow more LED light sources to be mounted on the light source plate in order to create a LED lamp with high power.

The detailed description of this invention is more apparent upon reading following preferred embodiments in conjunction with accompanying drawings.

### BRIEF DESCRIPTION OF THE DRAWINGS

FIG. 1 is a perspective view showing a first preferred embodiment of this invention;

FIG. 2 is a perspective view showing the first preferred embodiment of this invention in combination with a pin;

FIG. 3 is a cross-sectional view showing the first preferred embodiment of this invention in combination with an LED lamp;

FIG. 4 is a perspective view showing a second preferred embodiment of this invention;

FIG. 5 is a perspective view showing a third preferred embodiment of this invention;

FIG. 6 is a perspective view showing a fourth preferred embodiment of this invention;

FIG. 7 is a perspective view showing a fifth preferred embodiment of this invention;

FIG. 8 is a perspective view showing the fifth preferred embodiment of this invention in combination with a pin; and

FIG. 9 is a cross-sectional view showing the fifth preferred embodiment of this invention in combination with an LED lamp.

### DETAILED DESCRIPTION OF THE PREFERRED EMBODIMENTS

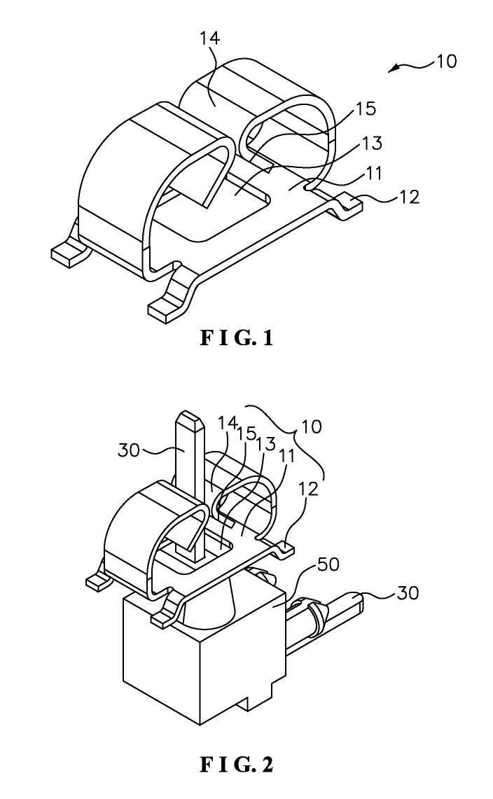

FIGS. 1-8 are five preferred embodiments of the head-hoop type connector of this invention which includes a bottom plate 11.

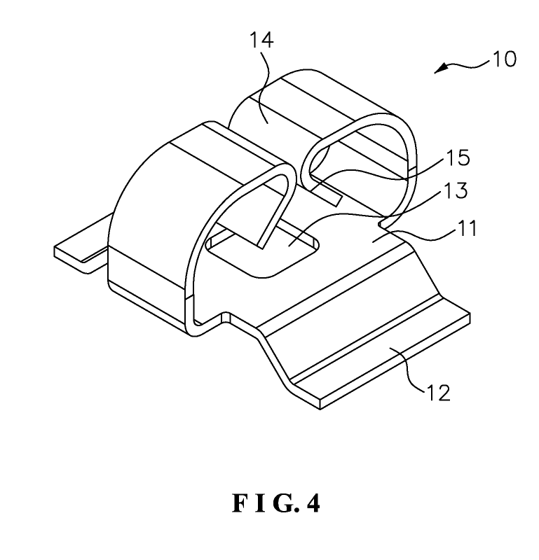

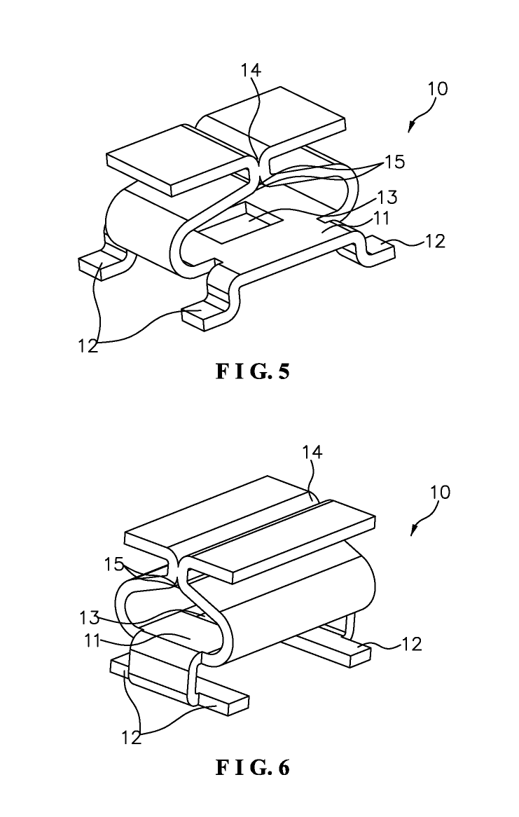

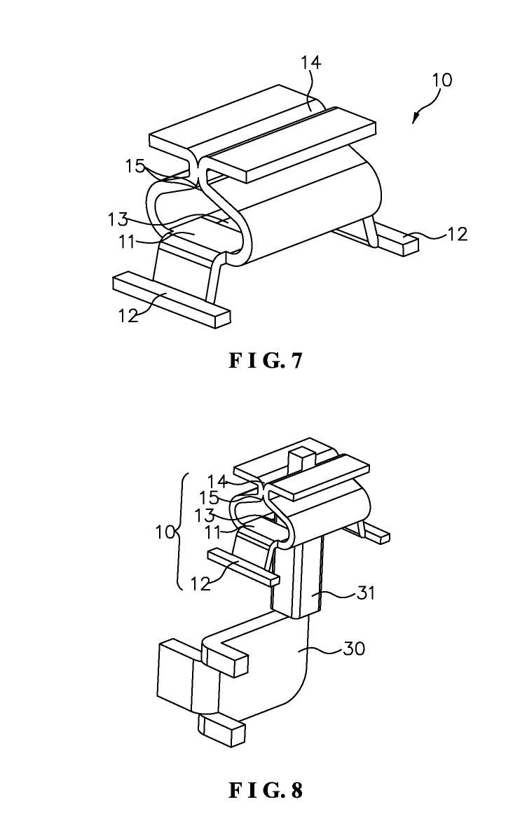

The bottom plate 11 has weld legs 12. The weld legs 12 have an electric connection with a light source plate 20. In the first preferred embodiment of FIG. 1 and the third preferred embodiment of FIG. 5, four weld legs 12 are disposed on the bottom plate 11. Specifically, two weld legs 12 are disposed on a left side of the bottom plate 11, and the other two weld legs 12 are disposed on a right side of the bottom plate 11. Thus, the bottom plate 11 has four corners, each of which forms a welding leg 12. In the second preferred embodiment of FIG. 4, two weld legs 12 are disposed, with one of the welding leg 12 disposed in the front of the bottom plate 11 and the other welding leg 12 disposed in the rear of the bottom plate 11. In the fourth preferred embodiment of FIG. 6 and in the fifth preferred embodiment of FIG. 7, two weld legs 12 are disposed, one of which is disposed in the front of the bottom plate 11 and the other one of which is disposed in the rear of the bottom plate 11. Herein, the fourth preferred embodiment of FIG. 6 shows that the front and the rear of the bottom plate 11 extend downwards respectively and get bent inwards to form the weld legs 12. The fifth preferred embodiment of FIG. 7 shows that the front and the rear of the bottom plate 11 extend downwards respectively and get bent outwards to form the weld legs 12. The fourth embodiment and the fifth embodiment show that the weld legs 12 are further stretched to the left and to the right in order to increase the welding area and obtain a firmer installation. These five preferred embodiments are distinguished because the weld legs 12 are situated at different places and formed into different structures. These differences can be adapted to LED light source plates 20 with different arrangements.

The bottom plate 11 forms a socket 13. A pin 30 can pass through the socket 13.

Two side edges of the bottom plate 11 extend upwards first, then relatively extend to a position above the socket 13 and thence get bent. Thus, the two bent side edges forms an elastic clamp 14 above the socket 13. The pin 30 can be inserted into the elastic clamp 14 to execute an electric connection. Referring to FIG. 1 and FIG. 4, the two side edges of the bottom plate 11 extend upwards to a position above the socket 13 and thence get bent downwards. This structure is simple Other bending structure can also be adopted to form the elastic clamp 14 and increase elasticity. A leading part 15 can be further formed at a lower part of the elastic clamp 14. This leading part 15 helps direct an insertion of the pin 30. Referring to FIGS. 5-8, after the two side edges of the bottom plate 11 extend upwards to a position above the socket 13, the side edges go upwards, then stretch to the left and the right, and thence get bent to form the elastic clamp 14. This structure can enhance the elasticity and the strength. The leading part 15 can be directly formed when the elastic clamp 14 above the socket 13 gets bent upwards. The pin 30 is inserted with the aid of the leading part 15.

After being shaped, the bottom plate 11 is formed in a hoop shape similar to the golden hoop of Sun Wu-Kong, the Monkey King in the novel Pilgrimage to the West. Thus, a head-hoop type connector is obtained.

Referring to FIG. 1 and FIG. 8, the structure of the head-hoop type connector of this invention is simple The structure can be made by pressing and bending a one-piece material. Thus, the cost is largely reduced. This connector can be installed without conventional plastic seats and can be installed with a more compact structure, thereby adapting the connector to LED lamps with different sizes and types, especially to small-sized LED lamps. Thus, the application range of this invention is broader. With regard to LED lamps with the same sizes and types, the more compact installation of this invention allow more LED light sources to be mounted on the light source plate to create a LED lamp with high power.

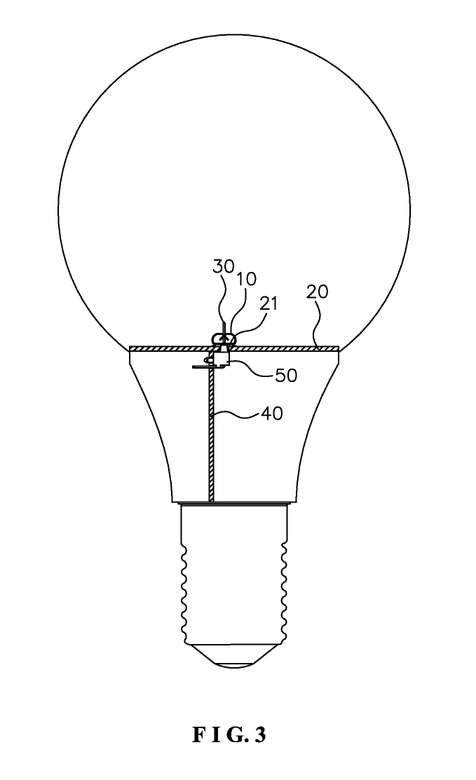

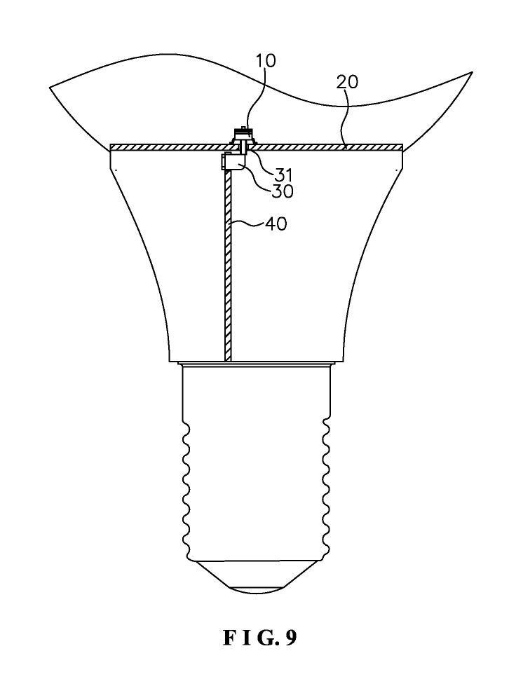

When the head-hoop type connector is applied to an LED lamp, a light source plate 20 and a drive plate 40, shown in the first preferred embodiment of FIG. 3, are installed within the LED lamp The drive plate 40 is located below the light source plate 20. The head-hoop type connector 10 is installed on the light source plate 20. An opening 21 is formed on the light source plate 20 relative to the socket 13 for the penetration of the pin 30. The pin 30, such as a pressed part or a conducting wire, can be installed on the drive plate 40 by a plastic seat 50. The pin 30 can also be directly formed on the drive plate 40 by welding, as shown in FIG. 8 and FIG. 9. The drive plate 40 can also be integral with the pin 30, a PCB. The insertion of the pin 30 into the elastic clamp 14 of the head-hoop type connector 20 provides an electric connection to illuminate.

To conduct a better connection and installation, to prevent the short circuit and especially to facilitate the installation of the pin 30 on the opening 21 of the light source plate 20, an insulation sleeve 31 can be disposed around a place of the pin 30 corresponding to the opening 21 of the light source plate 20.

While the embodiments of this invention are shown and described, it is understood that further variations and modifications may be made without departing from the scope of this invention.

What is claimed is:

1. A head-hoop type connector comprising a bottom plate, said bottom plate being provided thereon with weld legs which has an electric connection with a light source plate, said bottom plate forming a socket where a pin penetrate, a left side edge and a right side edge of said bottom plate extending upwards first, then relatively extending to a position above said socket and thence getting bent to form an elastic clamp where said pin is inserted to provide the electric connection.

2. The head-hoop type connector as claimed in claim 1, wherein said left side edge and said right side edge of said bottom plate extend upwards first, then relatively extend to a position above said socket and thence get bent downwards to form said elastic clamp.

3. The head-hoop type connector as claimed in claim 1, wherein said left side edge and said right side edge of said bottom plate extend upwards first, then relatively extend to a position above said socket and thence get bent upwards to form said elastic clamp.

4. The head-hoop type connector as claimed in claim 3, wherein said left side edge and said right side edge of said bottom plate extend upwards first, then relatively extend to a position above said socket, go upwards and further stretch left and right, and thence get bent to form said elastic clamp.

5. The head-hoop type connector as claimed in claim 1, wherein said bottom plate has four weld legs disposed thereon, two of said weld legs being disposed on a left side of said bottom plate, the other two of said weld legs being disposed on a right side of said bottom plate.

6. The head-hoop type connector as claimed in claim 1, wherein said bottom plate has two weld legs disposed thereon, one of said weld legs being disposed in a front of said bottom plate, the other one of said weld legs being disposed in a rear of said bottom plate.

7. The head-hoop type connector as claimed in claim 1, wherein said elastic clamp forms a leading part which leads an insertion of said pin.

8. The head-hoop type connector as claimed in claim 1, wherein said head-hoop type connector is formed by pressing and bending a one-piece material.

9. An LED lamp, characterized in that a drive plate and a light source plate are installed within said LED lamp, said drive plate being located below said light source plate, said head-hoop type connector as claimed in claim 1 being installed on said light source plate, an opening being formed on said light source plate relative to said socket for an insertion of said pin, said pin being installed on or integral with said drive plate, said pin being inserted into said elastic clamp of said head-hoop type connector to provide an electric connection.

10. The LED lamp as claimed in claim 9, wherein an insulation sleeve is disposed around a place of said pin corresponding to said opening of said light source plate.
